(19) United States
(12) Patent Application Publication
(10) Pub. No.: US 2026/0336363 A1
(43) Pub. Date: Oct. 29, 2026

(54) HEAT RADIATING TRIM PART FOR A VEHICLE COMPARTMENT

(71) Applicant: AUTONEUM MANAGEMENT AG, Winterthur (CH)

(72) Inventors: Edward BENDELL, Zürich (CH); Raphael MERRIEN, Winterthur (CH)

(73) Assignee: AUTONEUM MANAGEMENT AG, Winterthur (CH)

(21) Appl. No.: 18/995,124

(22) PCT Filed: Jul. 17, 2023
(86) PCT No.: PCT/EP2023/069801

§ 371 Date: Jan. 15, 2025

(30) Foreign Application Priority Data
Jul. 21, 2022 (EP) 22186348.3

(51) Int. Cl. B60H 1/22; B60R 13/02; H05B 3/36

(52) U.S. Cl. CPC B60H 1/2227; B60R 13/02; B60R 2013/0287; H05B 3/36; H05B 2203/003

(57) ABSTRACT

A heat radiating automotive trim part able to radiate heat into a vehicle compartment comprising a fibrous cover layer with at least one surface facing the compartment, a heater layer adjacent the fibrous cover layer comprising at least one metallic flat ribbon in a meandering shape, and an insulating layer adjacent the heater layer on the surface facing away from the compartment, whereby the heater layer further comprises at least one porous adhesive layer between the surface of the ribbon and at least one of the cover layer and the insulating layer, or between cover and the insulating layer, and whereby the adhesive layer covers at least the surface of the ribbon, and whereby the overall air flow resistance of the trim part is between 500 and 7000 Nsm⁻³, preferably between 1500 and 5000 Nsm⁻³, more preferably between 2000 and 3000 Nsm⁻³

This application is a national stage application under 35 U.S.C. 371 and claims the benefit of PCT Application No. PCT/EP2023/069801 having an international filing date of Jul. 17, 2023, which designated the United States, which PCT application claimed the benefit of European Patent Application No. 22186348.3, filed Jul. 21, 2022, the disclosure of each of which are incorporated by reference herein.

### BACKGROUND ART

The passenger compartment of a vehicle is traditionally warmed by heated air blown into the passenger compartment. This is an ineffective way of transporting heat to the passengers. Passenger comfort may be significantly delayed, and heat is lost to the surrounding car parts of the passenger compartment and by the circulation of air which ejects already-heated air from the vehicle.

Cars and passenger vehicles based on petrol/diesel engines are generally heated by blowing heated air using the heat coming from the powertrain and/or motor, generated during combustion of the fuel. In electric and hybrid-electric cars, this source of heat is no longer fully available. Hence, the vehicle is heated by the same electricity that the car needs for its driving range.

For an electric vehicle, this requires an electrical air-heating element, which results in a loss of energy, in particular at the beginning of a drive in an environment with low ambient temperatures.

Heated surfaces that radiate heat directly into the compartment to be heated, like the passenger compartment or smaller areas of the vehicle may form an alternative way of creating a warmer climate within the compartment. However, although heated radiant trim panels may be known, they are not commonly used.

Past trials to use these type of radiating panels where based for instance on surface heating devices including an embroidered wire, as are known in heated seats. However, an embroidered wire, while providing radiant heating to the passenger compartment, may have locally higher temperature as it does not cover a large surface area. In seats this is countered by a lower overall working temperature and by the direct contact of the user of the seat with the heated surface, hence the heating is not done via radiation but more a direct contact heating. Furthermore a temperature control system turns stops the heating upon reaching a pre-set temperature.

The use of heaters based on embroidered wire are however problematic in exposed areas, that may be used for radiant surfaces. The high temperatures these wires may achieve locally or on hot spots, may cause burns upon skin contact, so a thick insulation layer is necessary, thereby reducing the overall heat radiation and the efficiency.

The embroidered wire may be replaced by other resistive elements producing heat upon passage of an electric current known in the art, like carbon layers, or a woven material comprising many heating threads powered electrically in parallel.

To obtain a more robust heater the resistive element is placed or sandwiched between foils, for example chemically etching metal ribbons or carbon layers were placed onto or between a polymeric substrate.

However these foil type heaters have the disadvantage of a resource intensive process increasing the cost of the part furthermore the parts may still be unreliable and prone to puncture that may cause short-circuits.

All the heating devices may have sufficient coverage and may avoid local hot spots, but are fragile and easily broken or punctured, making manufacturing challenging and requiring more support structure to avoid shorts and part failures, or at the worst fire risks.

Acoustic attenuation provides an important function in battery-electric vehicles and electric vehicles, as low-frequency sources of noise such as the engine are removed and mid to high-frequency sources of noise persist such as wind noise and high-frequency motor noise.

As the majority of these radiant trim parts, comprise an impervious layer like foils or film type structures, the trim part may no longer contribute to enhanced noise attenuation. As in some of these part the impervious layer may be close to the surface of the part facing the compartment containing the noise, the part may even have a negative influence on the acoustic attenuation.

Furthermore the radiant panels according to the state of the art are restricted in the 3D shapes that may be achieved, in particular in most cases the radiant heater may only be used on flat areas of a part and not in curved areas as they are not able to be formed in a curved or 3D structure without the risk of breaking the wire or thin etched areas.

There is therefore a need for a radiant heating panel or trim part which forms an alternative to the state of the art mentioned, in particular which is robust in the radiating function while maintaining good surface uniformity and minimizing local hot spots and furthermore is able to contribute to the overall acoustic attenuation in the compartment and that may be used in curved positions as well.

### SUMMARY OF INVENTION

The object of the invention is achieved by a heat radiating automotive trim part able to radiate heat according to the main claim.

The heat radiating automotive trim part according to the invention comprises a fibrous cover layer with at least one surface facing the compartment to be heated, a heater layer adjacent the fibrous cover layer comprising at least one metallic flat ribbon in a meandering shape, and an insulating layer adjacent the heater layer on the surface facing away from the compartment. In particular, by including at least one porous adhesive layer between at least one of the surface of the ribbon and at least one of the adjacent layers, or between the adjacent layers, and whereby the adhesive layer is covering at least the surface of the ribbon, and whereby the glue layer is chosen such that the overall air flow resistance (AFR) of the trim part is between 500 and 7000 Nsm−3, preferably between 1500 and 5000 Nsm⁻³, more preferably between 2000 and 3000 Nsm⁻³, an acoustic attenuating trim part is achieved able to radiate heat at the same time.

The heat radiating trim part according to the invention not only shows an optimized heat radiating surface, it is also able to attenuate noise, in particularly by sound absorption.

Surprisingly, the heater layer formed by a combination of the open structure of the metal ribbon with a porous adhesive layer creates an air flow resistive layer with an air flow resistance (AFR) high enough to create an enhanced acoustic absorption.

The overall AFR is formed by the combined AFR of the fibrous cover layer, the heater layer and the insulating layer. Preferably the AFR of the fibrous cover layer and the heater layer together, is between 20 and 90%, preferably between 30 and 80% of the overall air flow resistance of the part.

Surprisingly, the heat radiating trim part according to the invention with the combination of a fibrous cover layer, a heater layer and an insulating layer whereby in particular the combination of an open structure of the ribbon combined with a porous adhesive layer together creates an acoustic system that may be optimized by either adapting the openness of the ribbon or the adhesive layer.

For instance, by reducing the width of the ribbon and/or increasing the alternation of straight areas and curved areas, the AFR may be adapted further.

Preferably, whereby the surface area of the actual ribbon comprises between 25 and 85% of the surface area formed by the calculated surface of the area inside the outer perimeter of the ribbon, preferably between 40 and 75%.

Preferably the width W of the ribbon is between 3 and 50 mm, more preferably between 5 and 20 mm.

The thickness T of the ribbon may be substantially constant. To obtain a robust system, which is easy to bend in a 3-dimensional structure if necessary. The thickness T is preferably between 30 and 500 microns, preferably between 50 and 300 microns, and more preferably between 150 and 250 microns.

The metal ribbon may be based on any metal able to produce heat upon passage of an electric current, preferably it is made of at least one of steel, copper, nickel, zinc, tin, or alloys of such materials, and/or combination of such materials.

The heater may be coated or anodized to adjust the emissivity, however, preferably the heater layer is uncoated before stamping or cutting to aid the recyclability of the off-cuts.

The heater may also comprise a layer of nonwoven material woven between the straight areas of the steel ribbon to prevent short circuits, preferably with an area weight less than 100 gsm, more preferably less than 50 gsm.

The heater may comprise a smaller diameter at the end of the ribbon for the purposes of crimping or connecting to a source of power for heating.

Although the ribbon is contributing to the overall AFR according to the invention its main purpose is the passage of a current to generate heat that can radiate into the compartment. The ribbon is stamped or cut out of a plate material in a pattern of alternating straight connected by curved areas. The curved areas preferably comprise a 10% to 40% reduction in width at least on the side of the inner curve. This reduces the possibility of creating hot spots in the area of the curves.

The porous adhesive layer may further contribute to the overall AFR. Preferably, the porous adhesive layer comprises an area weight of 20 to 300 g/m², preferably 20 to 150 g/m² to prevent a too thick layer and hence a too high AFR. Preferably, the adhesive is chosen such that it is able to at least partially wick and bind to the adjacent layers, whereby this wicking may also redistribute the adhesive creating a more porous structure with the adjacent layers.

Preferably the porous adhesive layer is a thermoplastic adhesive, preferably one of a polyester, a thermoplastic polyurethane, a polyamide, or a copolymer of styrene-butadiene, more preferably one of the series of poly(ethylene terephthalate) copolymers. Preferably, the material used for the adhesive layer is compatible with the adjacent layers, more preferably at least the insulating and/or fibrous cover layer are based on the same polymer family.

The thermoplastic adhesive may be in the form of an extruded layer, a fibrous layer, powder adhesive, or a perforated film layer which melts during thermal processing to provide adhesion between the fibrous cover layer, the heater layer, and the insulating layer while maintaining the porosity and therefore the overall AFR of the part.

The adhesive layer may also comprise a flame retardant, especially one of the phosphate or nitrogen containing materials such as but not exclusively limited to melamine or ammonium polyphosphate, or a VOC reducing additive such as activated carbon.

All materials of the different layers in particularly the adhesive layer are chosen such that they are not melting or disintegrating during use of the heating function.

The fibrous cover layer may contribute to different functions in the trim part. The first function is the enablement of the radiated heat to enter the passenger compartment, for this the fibrous cover layer needs to be a substantially open structure. A perfect system would not need a fibrous cover layer as the radiation transferred directly to the passengers would be the optimal solution. However this would mean that the temperature of the surface may be low to prevent heat injuries by touching. At the same time, reducing the surface heat temperature would reduce the capacity of the heater to heat the surrounding area.

Surprisingly, it was found that using a surface with an open structure material would enable a near to unobstructed passing of the radiation through the material while also creating a touch barrier enough to prevent serious injuries. Preferably, the fibrous cover layer comprises at least one of a knit, a scrim, a nonwoven, a tufted carpet, a nonwoven carpet, or a spacer fabric.

The fibrous cover layer may comprise of a density between 50 and 250 kg/m³, preferably between 50 and 100 kg/m³.

For instance, a possible cover layer may be a combination of a knit layer and a non-compressed consolidated nonwoven layer having regular holes punched in it. Whereby the full surface of the nonwoven layer including the holes is covered by the knit in the direction of the surface.

The fibrous cover layer also preferably comprises a minimum thickness of 1 mm, more preferably 2 mm, in order to maintain touch safety in the vehicle.

The fibrous cover layer may comprise an additional membrane or vapor barrier, so long as it does not hinder the porous nature of the trim part, which is to say that it does not render the AFR outside of the claimed levels.

The fibrous cover layer may also comprise a combination of layers, preferably a thicker nonwoven layer, preferably greater than 1 cm in thickness, with a regular pattern of holes cut into the surface, preferably less than 1 cm in diameter, bonded to a thinner knit or nonwoven. This arrangement minimizes overall area weight while maximizing distance from the touch surface to the surface of the radiative heater layer.

The fibrous cover layer may also comprise, for example, a thin nonwoven or a knit covering and bonded to the heater layer and a spacer fabric molded over, covering, and bonded to the thin nonwoven.

The material of the fibrous cover layer, the insulating layer, and the adhesive layer of the heat radiating automotive trim part according to the invention, may be of same polymer family, preferably a polyester, more preferably a terephthalate-based polyester and/or copolymers or blends of terephthalate-based polyester. This would enable an easier process for separation and recycling of the materials. Preferably, the ribbon is of a steel or magnetic attracting material whereby the whole part may be shredded and the steel particles taken out by magnetic separation methods. A chemical denaturation process leaving the metal part behind may also be a possible solution to recycle both off cuts during production or end of life or rejected part later.

The insulating layer may be one single layer or a combination of layers and may comprise at least one of a porous foam layer or a fibrous layer. Overall, the insulating layer should be porous to enable an AFR.

Preferably, when a fibrous material is used, the fibers or continuous filaments may be from a virgin, reclaimed, or recycled source.

Foams may be used to further enhance the heat radiating function or the acoustic function of the part or any other requirements, like stiffness or gap filling capacity. Open foam materials, such as melamine, polyurethanes, polyolefins and/or polyimides may be used.

Preferably, the insulating layer comprises a final density between 50 and 300 g/m³, more preferably between 50 and 150 g/m³.

The insulating layer may comprises a molded thickness between 7 and 20 mm, more preferably between 7 and 20 mm. Preferably this layer is varying in thickness to level out any level difference between the surface and the panel or space it is placed in.

The insulating layer may comprise a porous water barrier such as a spunbond polypropylene, polyethylene, polyamide or polyester with properties that resist water penetration but are still porous and able to maintain or add to the overall AFR of the part.

In case the heat radiating trim part according to the invention is used as a structural part or needs a structural stiffness, the insulating layer may be compressed to form a stiffer layer, thereby creating a structural stiffness to the overall trim part.

As the insulating layer may be one layer or a combination of layers, the full layer or a layer within the insulating layer may add to or create the overall stiffness.

The stiffer layers may be molded to include ribs or protrusions for the purposes of adding stiffness to the overall part.

The use of metal for the ribbon has the advantage of shaping in a 3-dimensional shape like a curve or bowl type shape. This may be done in a process with all layers stacked and the part molded and consolidated in one step. Whereby consolidated would mean that any binder within the layers would bind the fibers in that same layer to each other at least at contacting points, while at the same time the adhesive layer would bind to the adjacent layer being either the ribbon, and or the cover layer, and or the insulating layer. At the same time, the metal ribbon is formed in the same overall shape following the rough bending of the part where necessary. However, there may be a risk of the sliding of the heater during the molding process. To prevent this it may be preferably to integrate reinforcing polymer structures, such as rivets, stitches, or pre-needled areas, to prevent the steel ribbon from changing position during use or production. These may be temporary solutions, for instance a pre-stitching to an adhesive fibrous layer, that will melt during production or more permanent solutions. This may be depending on the nature of the trim part and the orientation it is used in.

The AFR is measured according to ISO9053 using the direct airflow method (Method A). For the measurements shown a Care+ unit as commercially available from Autoneum was used following the standard proceedings according to the manual thereto. As the ribbon might not give even distribution over the surface an average of at least 10 measurement point is taken to define the overall AFR of the part in the area including the heater. The measurement points may be overlapping for not more than 40%.

The heat radiating automotive trim part may be located on any surface of a vehicle that is facing an compartment in need for increasing temperature. This might be areas with only a mild need, like for instance the front or back trunk compartments, or as an initial or background heater for instance in the main passenger compartment for instance integrated in the door as a door panel, the foot area for instance as an inner dash panel or an under dash panel, the tunnel area, an headliner, a trim part on the back of the front chair directed to the second passenger row, the back or part of the headrest, local areas on the flooring, or any other area where the occupant of the vehicle is not in direct contact with the trim part in question. A combination of trim part according to the invention might be used in a car, to either warm the compartment during the use of the vehicle or as stand heater before the car is used or in between use phases.

### BRIEF DESCRIPTION OF DRAWINGS

Figure is a cross-section of a heat radiating automotive trim part flat.

FIG. 2 is a 3D shaped version of the heat radiating automotive trim part.

FIG. 3 is an example of the metallic flat ribbon forming the resistive heater.

### DETAILED DESCRIPTION

FIG. 1 is showing a heat radiating automotive trim part 1 able to radiate heat into a vehicle compartment comprising a fibrous cover layer 2 with at least one surface facing the compartment, a heater layer 3 adjacent the fibrous cover layer 1 comprising at least one metallic flat ribbon 4 in a meandering shape, at least one porous adhesive layer 6 between the surface of the ribbon 4 and/or at least one of the adjacent layers 2 or 5 or between the layers 2 and 5. The trim part further comprises an insulating layer 5 adjacent the heater layer 3 on the surface facing away from the compartment.

The combination of the ribbon and the adhesive layer together form an air flow resisting layer. The ribbon by partly closing the surface of the insulating layer underneath it, increases the air flow resistivity in the areas not covered by the ribbon. In addition, in the areas between the ribbon, the cover layer and the insulating layer are laminated together by the adhesive layer. The porous adhesive, together with the adjacent layers forms an air flow resistance. Both areas together form the advantageous overall air flow resistance that increases the noise attenuation.

The lower insulating layer becomes available for acoustic absorption from both sides of the trim part enhancing the overall noise attenuation.

Hence, the overall air flow resistance of the trim part is between 500 and 7000 Nsm⁻³, preferably between 1500 and 5000 Nsm⁻³, more preferably between 2000 and 3000 Nsm⁻³.

The fibrous cover layer 2 may be a combination of layers (not shown in the figure), preferably a thicker nonwoven layer, preferably greater than 1 cm in thickness, with a regular pattern of holes cut into the surface, preferably less than 1 cm in diameter, bonded to a thinner knit or nonwoven. This arrangement minimizes overall area weight while maximizing distance from the touch surface to the surface of the radiative heater layer. The fibrous cover layer may be comprised of virgin, reclaimed or recycled polyester, polyamide, polyolefin, polyurethane, cellulose, protein, or poly(vinyl chloride), preferably polyester or polyamide. The fibrous cover layer at polymer level may comprise additives for flame retardancy, color, or odor reduction.

The insulating layer 5 may also comprise of multiple layers of fibrous materials (not shown in the figure). In order to add stiffness to the part, a more highly compressed layer may be added to the insulating layer to support the part. This highly compressed layer may also comprise reinforcing fibers such as glass fiber.

Preferably, the entire part aside from the metallic ribbon is fibrous and made from the same polymer family to aid in recyclability.

FIG. 1 is further showing the cross section of the ribbon with a thickness T indicated in the drawing.

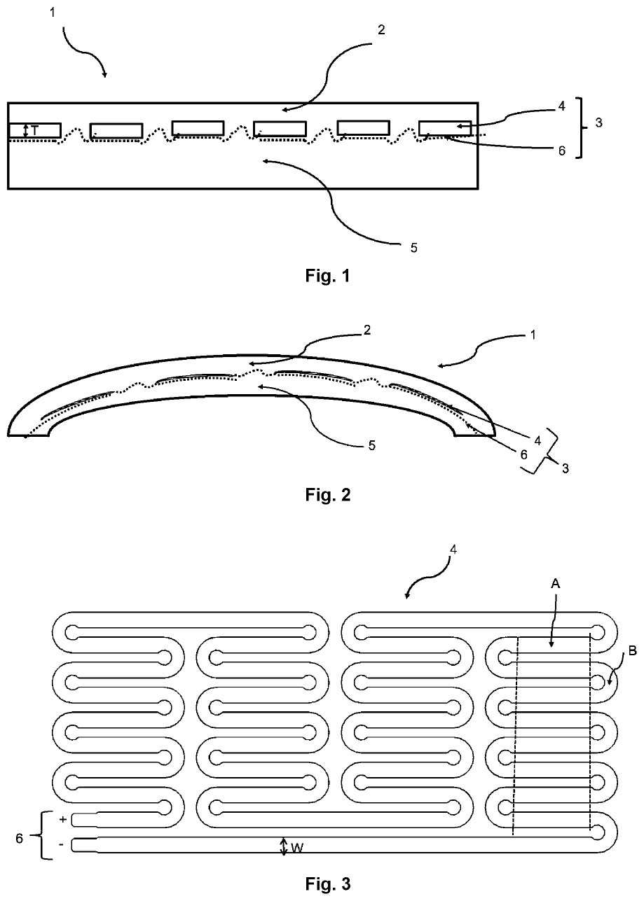

FIG. 2 is showing an example of a curved automotive heat radiating trim part 1 according to the invention. The same numbering is used as in FIG. 1. The part as shown has been molded into a 3-dimensional shape and is curved, whereby also the heater layer 3 is curved to follow the shape of the part. To maintain a 3 dimensional form, that is preferably self-supporting, it might be beneficial to include binder preferably binder fibers in the cover and or insulating layer. Upon thermal molding the layers will be consolidated and the adhesive layer will bind to the adjacent layers forming the final trim part in a 3 dimensional shape.

FIG. 3 is showing the metallic ribbon 4 on its own viewed from the top side. The ribbon may be stamped or cut from a flat sheet of metal. The metal ribbon is working as a resistive heater, whereby a current is running through the ribbon and thereby produces heat. The ribbon is connected to a + and − pole 6 to enable the application of an electric current. The heat is radiating of the surface through the cover layer. The ribbon is organized as straight areas A and curved areas B (A and B are showing an example of a straight area and a curved area.) to further optimize the evenness of the heating over the full surface.

The ribbon may have variations in width to further optimize the current and or prevent hot spots. Furthermore, the figure shows an example of a ribbon layout, other lay outs may be used depending on the shape and size of the trim part. Furthermore, multiple ribbons may be used within one trim part. Or a trim part may have only in a smaller area an integrated ribbon.

1. A heat radiating automotive trim part able to radiate heat into a vehicle compartment comprising a fibrous cover layer with at least one surface facing the compartment, a heater layer adjacent the fibrous cover layer comprising at least one metallic flat ribbon in a meandering shape, and an insulating layer adjacent the heater layer on the surface facing away from the compartment, characterized in that the heater layer further comprises at least one porous adhesive layer between the surface of the ribbon and at least one of the cover layer and the insulating layer, or between cover and the insulating layer, and whereby the adhesive layer covers at least the surface of the ribbon, and whereby the overall air flow resistance of the trim part is between 500 and 7000 Nsm⁻3.

2. The heat radiating automotive trim part according to claim 1, whereby the air flow resistance of the fibrous cover layer and the heater layer together, is between 20 and 90%.

3. The heat radiating automotive trim part according to claim 1, whereby the surface area of the actual ribbon comprises between 25 and 85% of the surface area formed by the calculated surface of the area inside the outer perimeter of the ribbon.

4. The heat radiating automotive trim part according to claim 1, whereby the porous adhesive layer is a thermoplastic adhesive, preferably one of a polyester, a thermoplastic polyurethane, a polyamide, or a copolymer of styrene-butadiene.

5. The heat radiating automotive trim part according to claim 1, whereby the porous adhesive layer comprises an area weight of 20 to 300 g/m².

6. The heat radiating automotive trim part according to claim 1, whereby the ribbon comprises straight areas connected by curved areas, and whereby the curved areas comprise 10% to 40% reduction in width at least on the side of the inner curve.

7. The heat radiating automotive trim part according to claim 1, whereby the width of the ribbon, is between 3 and 50 mm.

8. The heat radiating automotive trim part according to claim 1, whereby the thickness of the ribbon is substantially constant, is between 30 and 500 microns.

9. The heat radiating automotive trim part according to claim 1, whereby the metal-metallic flat ribbon is based on at least one of steel, copper, nickel, zinc, tin, or alloys of such materials, and/or combination of such materials.

10. The heat radiating automotive trim part according to claim 1 whereby the fibrous cover layer comprises at least one of a knit, a scrim, a nonwoven, a tufted carpet, a nonwoven carpet, or a spacer fabric.

11. The heat radiating automotive trim part according to claim 1, whereby the fibrous cover layer comprises a density between 50 and 250 kg/m³.

12. The heat radiating automotive trim part according to claim 1, whereby the insulating layer comprises at least one of a porous foam layer or a fibrous layer.

13. The heat radiating automotive trim part according to claim 1, whereby the material of the fibrous cover layer, the insulating layer, and the adhesive layer are of the same polymer family, preferably a polyester, more preferably a terephthalate-based polyester and/or copolymers or blends of terephthalate-based polyester.

14. The heat radiating automotive trim part according to claim 1, whereby all layers may comprise reinforcing polymer structures such as rivets, stitches, or points where the layers are needled to further prevent the steel ribbon from changing position during use or production.
